(19) United States
(12) Patent Application Publication
(10) Pub. No.: US 2007/0243368 A1
(43) Pub. Date: Oct. 18, 2007

(54) Composite article

(76) Inventor: Christopher M. Edwards, Midland, MI (US)

Correspondence Address: Timothy S. Stevens, 5108 Foxpoint Circle, Midland, MI, 48642, US

(21) Appl. No.: 11/716,167

(22) Filed: Mar. 9, 2007

(30) Foreign Application Priority Data
Oct. 11, 2005 (US) PCT/US05/36364

(51) Int. Cl. D04H 13/00; B32B 27/04; D04H 1/00

(52) U.S. Cl. 428/292.1; 428/297.4; 428/300.4

(57) ABSTRACT

An article wherein one region of continuous fiber composite is mated to another region of randomly dispersed discontinuous fiber composite. For example, a bolt having its threaded portion molded of a random fiber/thermoplastic resin composite overmolded onto a continuous fiber pultruded composite core.

### PRIORITY

This application claims priority from U.S. Provisional Application No. 60/618,291 filed Oct. 13, 2004 and International Application Number PCT/US2005/036364 filed 11 Oct. 2005.

### FIELD

The instant invention relates to composite articles and more specifically the instant invention relates to composite articles comprising a continuous fiber composite combined with a non-continuous fiber composite.

### BACKGROUND

U.S. Pat. No. 6,346,325 B1 issued to Christopher M. Edwards and Edward L. D'Hooghe on Feb. 12, 2002 disclosed a fiber-reinforced composite encased in a thermoplastic and a method for making such a composite. The technology provided by the '325 patent was a significant advance in the art of continuous fiber composites. However, the technology provided by the '325 patent does not provide sufficient strength properties off axis from the axis of the continuous fibers of the composite, which properties would be of significant benefit for many applications if only they could be realized.

### SUMMARY OF THE INVENTION

The instant invention is a solution, at least in part, to the above stated problem. The instant invention is a continuous fiber composite having significantly improved properties off axis from the axis of the fibers of the continuous fiber composite.

More specifically, the instant invention is an article comprising: (a) one or more regions of aligned continuous fiber composite; and (b) one or more regions of composite containing randomly dispersed fibers.

### BRIEF DESCRIPTION OF THE DRAWINGS

FIG. 1A is a perspective view of an article of the instant invention having a core consisting of a continuous fiber composite sandwiched between outer layers of substantially random fiber composite;

FIG. 1B is a perspective view of another article of the instant invention having a core consisting of substantially random fiber composite sandwiched between outer layers of a continuous fiber composite;

FIG. 2A is a perspective view of an article of the instant invention having a tubular core consisting of a continuous fiber composite and an outer layer of substantially random fiber composite;

FIG. 2B is a perspective view of an article of the instant invention having a tubular core consisting of substantially random fiber composite and an outer layer of a continuous fiber composite;

FIG. 3A is an end view of an I beam of the instant invention consisting of an upper and lower sections of a continuous fiber composite and a central section of substantially random fiber composite;

FIG. 3B is an end view of an I-beam of the instant invention consisting of an outer portion of a continuous fiber composite and a selected inner section of substantially random fiber composite;

FIG. 3C is an end view of an I-beam of the instant invention consisting of a selected portion of a continuous fiber composite and a selected section of substantially random fiber composite;

FIG. 4A is a perspective view of a threaded rod of the instant invention having a core consisting of a continuous fiber composite and an outer layer of substantially random fiber composite molded at the surface thereof in the shape of threads;

FIG. 4B is a perspective view of a threaded rod of the instant invention having a tubular core consisting of a continuous fiber composite and an outer layer of substantially random fiber composite molded at the surface thereof in the shape of threads;

FIG. 5A is a cross-sectional view of a bolt of the instant invention having a solid core;

FIG. 5B is a cross-sectional view of a bolt of the instant invention having a tubular core; and

FIG. 5C is a cross-sectional view of a bolt of the instant invention having a tubular core of varying internal diameter.

### DETAILED DESCRIPTION OF THE INVENTION

Pultrusion refers to a process for producing continuous fiber composite profiles. Pultrusion is a desirable method to make composites because pultrusion is a continuous process.

The process consists of pulling continuous fibers (glass, carbon, aramid or other) through a die, impregnating them with a matrix resin and forming the resin and fibers to a final cross sectional shape.

Most pultrusion is carried out with a thermoset resin matrix such as polyester, vinyl ester, epoxy, or phenolic. More recently resins and processes have been developed to produce pultrusions with thermoplastic as the matrix resin. Examples include ‘Fulcrum’ (Edwards et al—U.S. Pat. Nos. 6,165,604 & 5,891,560), PVC plastisols, cyclic butylene terephthalate, polybutylene terephthalate, co-mingled fibers of polypropylene, PET and other resins, production of thin tapes or rods with other polymers which are subsequently consolidated to a larger profile and others.

As a result of the continuous fibers, pultruded profiles have excellent mechanical properties along their length. However since the fibers are usually substantially 100% unidirectional, the composite is relatively weak, brittle and flexible across its width and has a tendency to split as wood does, along the grain, especially when the section thickness is small compared to the overall dimensions. Also, such composites tend to have relatively low torsional, shear and buckling properties.

In thermoset composites these difficulties are overcome by using various means to provide off-axis fibers in the profile. These means include: drawing layers of non-axial fibers into the die along with the axial fibers. These layers may be woven cloth or mat, random fiber mats, stitched mats, etc. Another means of overcoming the low off-axis properties, especially in producing thin-walled hollow tubes, is to wind continuous fibers in a shallow spiral in between layers of axial fibers (‘pullwinding’). These alternatives, to an extent, overcome the problem of low off axis and shear properties in thermoset composites, but are difficult to apply when manufacturing thermoplastic composites. Also even in thermoset composites such approaches are not completely satisfactory because they add cost and complexity to the process and are limited in how and where they can be applied.

A further disadvantage of both thermoset and thermoplastic composites is that if it is necessary to cut the surface of the composite, for example to tap a thread onto the surface of a rod, then in doing so the continuous fibers are cut. Once cut, the local strength of the composite is dramatically diminished. Also the chemical resistance of the composite is compromised because in the area of the cut the ends of the fibers are no longer protected by the matrix and are exposed to chemical attack.

It would be desirable for pultrusions to have a means of enhancing the off-axis properties of the composite which do not have the limitations of the existing techniques known for thermoset composites.

The instant invention describes a means of overcoming the current limitations by, for example, pultruding thermoplastic composites using existing techniques while either simultaneously or subsequently combining the pultrusion with a second thermoplastic composite containing substantially randomly dispersed discontinuous reinforcement fibers. The second, substantially random fiber filled component is positioned either within or external to the continuous fiber component to provide off-axis properties in the position most beneficial to the desired structural properties.

The substantially random fiber filled component ideally has a matrix resin which is similar to and compatible with the matrix resin of the continuous fiber component. The substantially random fiber component can be incorporated directly by feeding from an extruder into directing slots in the same die that produces the continuous fiber component, or can be extruded onto or around the continuous fiber component after it exits it's own die or can be injection or compression molded in a single or multiple shots around the continuous fiber component in a subsequent operation.

A further advantage of this aspect of the instant invention is that, unlike the use of off-axis fiber mats in existing pultrusions, the random fiber thermoplastic compound can be varied in thickness and position more readily. A particularly advantageous type of random fiber filled composite is so called long fiber filled thermoplastic compounds of the type manufactured by Ticona, RTP and GE/LNP companies. These compounds are distinct from other fiber filled compounds in that the fiber length in the granules is typically 12 mm (though it may vary from 6 mm to 100 mm) while conventional fiber filled compounds have shorter fibers, typically less than 6 mm. This additional fiber length imparts enhanced properties particularly desirable in enhancing the off axis properties of the continuous fiber composite. Typical fiber content for these compounds ranges from 30 to 60% by weight, but may range from 10 to 75% by weight of fiber.

When overmolded or overextruded in relatively thin sections, the long fibers become aligned within the thickness of their plane while remaining more random across and along the plane. The random dispersion and random direction of these fibers gives properties which are more homogenous and less anisotropic than the continuous fiber component. Such reduced anisotropy, while giving the material significantly lower properties in the longitudinal direction than the pultruded composite, results in significantly higher properties in all other directions making the second discontinuous random fiber filled component much more suited to carry loads in all directions other than longitudinal, including shear and torque loads.

Another aspect of the instant invention is that it provides a means to provide regular or individual protuberances on the surface of the composite having at the same time improved mechanical properties. One form of these protuberances is threads so as to create a continuously threaded rod. The threaded rod has enhanced torsional and thread shear properties as a result of the substantially random alignment of the reinforcing fibers. A second form is to create features on the surface of the continuous fiber composite profile which are useful in the functional performance or assembly of articles manufactured from the composite profile. By way of example these features may be local features to provide strengthening in areas of high load or stress such as areas in which it is necessary to drill a hole in the continuous fiber composite. Also by way of example they may be fastening features molded onto the continuous fiber composite profile to facilitate joining to other articles.

Using techniques well known in the art (see, for example the teachings of the above-referenced '325 patent) one or more shapes are pultruded by pulling rovings of continuous fibers into a die into which, for example, molten thermoplastic resin is also fed. The continuous fibers are impregnated and wetted out by the thermoplastic and forced into the desired shape by pulling them through a portion of the die which has that shape. Before the pultruded shape(s) exit the die a second thermoplastic polymer containing substantially randomly dispersed discontinuous fibers is introduced into the die. The second thermoplastic in this embodiment of the instant invention is chosen to be chemically compatible with the first. The second thermoplastic is directed through slots in the die to shape it and bring it into contact with the pultruded sections.

As the molten polymers in the two sections come into contact with each other they form a strong bond as a result of the heat and pressure and their chemical compatibility. The resultant total profile consists of portions of the profile in which the material is thermoplastic with continuous unidirectional fibers along its length and portions in which the material is thermoplastic with discontinuous fibers substantially randomly oriented.

It should be understood that the term “substantially randomly oriented” means not only true random orientation, but also some degree of orientation that occurs during the molding operation, but not the essentially longitudinal orientation of the continuous fiber composite. It should also be understood that the matrix of the continuous fiber composite and/or the matrix of the substantially random fiber composite can comprise a thermoset polymer. When the matrix of the continuous fiber composite and/or the matrix of the substantially random fiber composite comprises a thermoset polymer, then in order to achieve a good bond between the continuous and discontinuous composites it is preferred that the second composite is introduced before the first composite has fully cured. Alternatively, it may be preferred to use an adhesive between them or to roughen their surfaces to enhance adhesion between them.

The second preferred thermoplastic component, containing the substantially randomly oriented fibers, can alternatively be combined with the continuous fiber pultruded shape(s) in a second die after the shape(s) exit the first die. This produces the same kind of combined profile containing portions of continuous and random fibers. This method can have the advantage of simpler dies.

Alternatively, the second preferred thermoplastic component containing the discontinuous substantially randomly oriented fibers can be combined with the continuous fiber pultruded shapes in a molding operation performed either in-line with the pultrusion or off line after the pultrusion of the continuous fiber composite is complete. Again this produces the same kind of combined profile containing portions of continuous and random fibers. This variation of the process has the advantage that the shape of the portion containing discontinuous fibers is no longer limited to being two dimensional. For example, repeating features such as threads can readily be incorporated.

It will be appreciated that in addition to the profile having fiber architecture suitable to resist the applied loads it is also beneficial to have an excellent bond between the two components. In general this bond is created as a result of the heat and pressure of the process and the chemical compatibility of the two preferred thermoplastic portions. In a second embodiment of this invention the bond between the two components may be further enhanced when molding the second thermoplastic component, by using the heat and pressure of the molding operation to deform the first component, such that a mechanical interlock or undercut is formed between the two components. This can be done continuously as described above or in discrete sections of overmolding.

In any of the above variations, the proportion of continuous fibers to discontinuous fibers within the profile may vary in any desired proportion, but preferably is from 90% continuous aligned fibers, 10% discontinuous random fibers to 10% continuous aligned fibers, 90% discontinuous random fibers. The positioning and proportions of the continuous and discontinuous portions within the profile is determined by the required properties of the profile. In particular the amount and position of the discontinuous fibers is determined by the required resistance of the profile, both globally and locally to shear, torque and bending loads perpendicular to the axis of the profile.

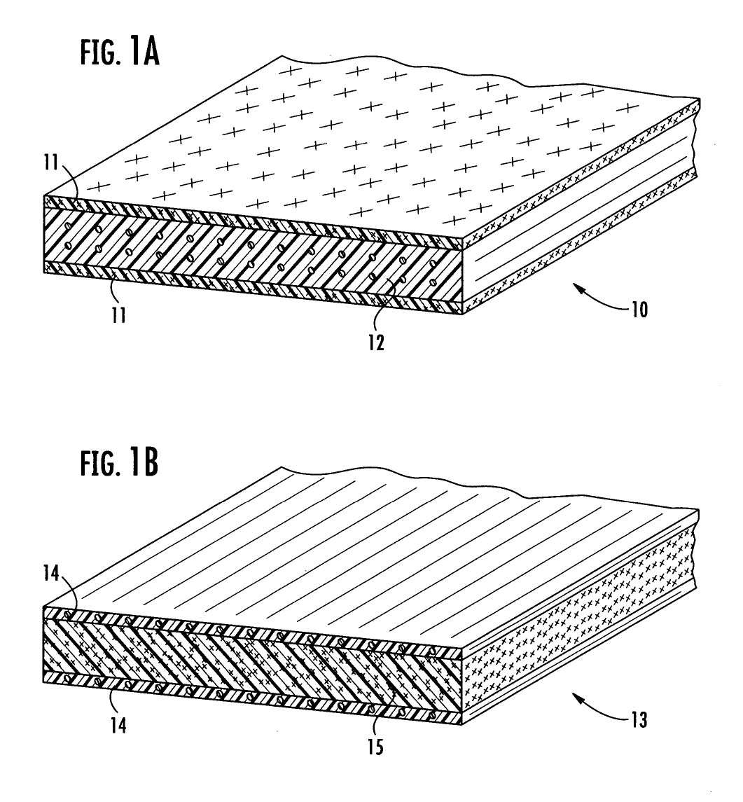

Referring now to FIG. 1A, therein is shown a simple rectangular profile 10 comprising layers 11 consisting of random fiber composite and layer 12 consisting of continuous fiber composite. Referring now to FIG. 1B therein is shown a simple rectangular profile 13 comprising layers 14 consisting of continuous fiber composite and layer 15 consisting of random fiber composite.

As a general principal of mechanics, when a profile is subject to bending or torsion, the portion of the section furthest away from the neutral axis (that plane or line in the section which remains unchanged in length) has the greatest effect in resisting loads. Therefore in the simple rectangular profiles shown in FIGS. 1A and 1B the off-axis portion would be more effective in resisting cross-ways bending as shown in 1A while as shown in 1B they would be considerably less effective at resisting cross-ways bending but the overall profile would be more effective at resisting bending in the lengthways direction while still having good resistance to splitting.

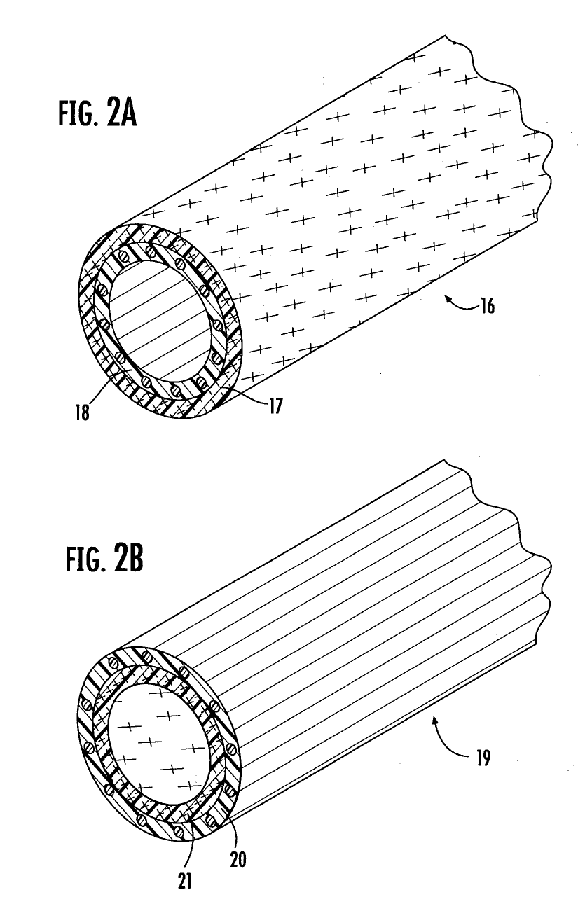

Referring now to FIG. 2A, therein is shown a tubular profile 16 comprising layer 17 consisting of random fiber composite and layer 18 consisting of continuous fiber composite. Referring now to FIG. 2B therein is shown a simple tubular profile 19 comprising layer 20 consisting of continuous fiber composite and layer 21 consisting of random fiber composite. In FIG. 2A the profile would have better resistance to torsional loads, buckling or splitting but lower bending properties while in FIG. 2B the profile would have better bending properties but less torsional resistance.

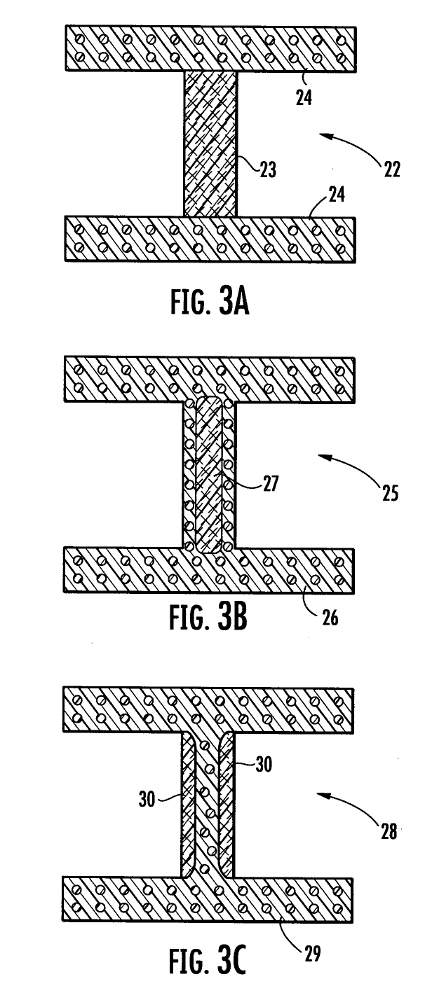

Referring now to FIG. 3A, therein is shown an “I” beam profile 22 wherein region 23 consists of random fiber composite and region 24 consists of continuous fiber composite. Referring now to FIG. 3B, therein is shown another “I” beam profile 25 wherein region 27 consists of random fiber composite and region 26 consists of continuous fiber composite. Referring now to FIG. 3C, therein is shown yet another “I” beam profile 28 wherein region 30 consists of random fiber composite and region 29 consists of continuous fiber composite. In general “I” beams are designed to resist bending. The top and bottom flanges contain a large proportion of the total section and are placed as far as practically possible from the neutral axis. When a bending load is applied to the beam as shown, these flanges resist the load in tension and compression respectively. The web in-between the flanges serves to resist the shear forces generated by the bending. While the uniaxial composite is well suited to resist the tension and compression in the flanges a random fiber is better suited to resist shear forces. The shapes shown in FIGS. 3A, B and C represent various options for how to utilize the continuous fiber composite to resist tension and compression in the flanges while using the random fibers to resist shear in the web.

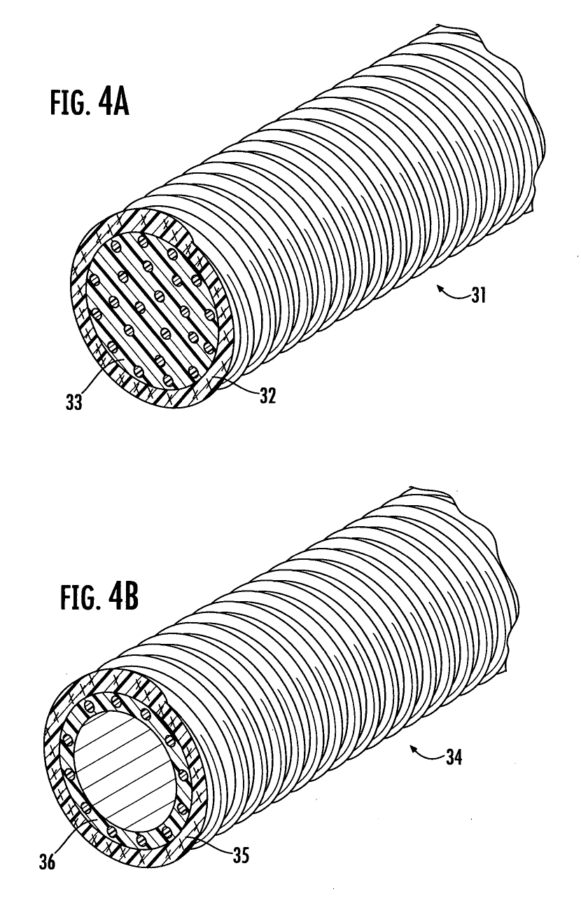

Referring now to FIG. 4A, therein is shown a threaded rod profile 31 wherein region 32 consists of random fiber composite while core 33 consists of continuous fiber composite. Referring now to FIG. 4B, therein is shown another threaded rod profile 34 wherein region 35 consists of random fiber composite while inner tubular portion 36 consists of continuous fiber composite. Typically threaded rods must resist both torque and tension. As before, the outer layer of material is most effective in resisting torque so substantially random fibers are usually best utilized here. The tensile load is carried by the uni-axial core, either solid, as shown in 4A or hollow tube as shown in 4B. In threads a further critical load must be resisted; the force from the mating thread which tends to shear off the threads themselves. Both the structures shown in FIGS. 4A and B are well adapted to resist these loads as the substantially random fibers on the outside both resist the applied torque loads and the shear loads on the threads.

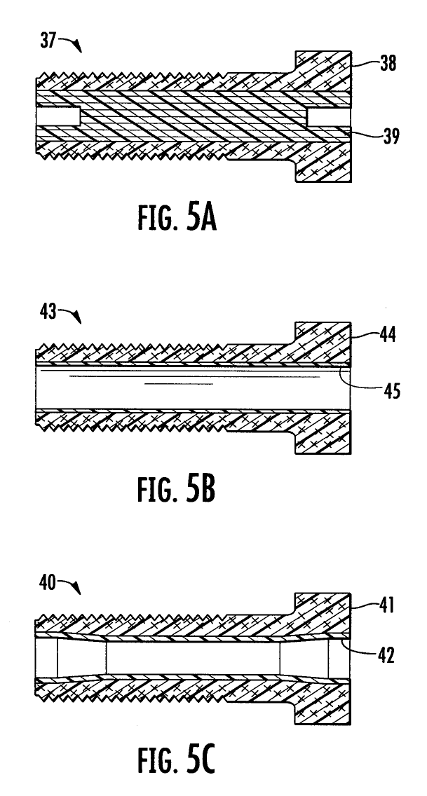

Referring now to FIG. 5A therein is shown FIG. 5A, a bolt 37 wherein the head, shaft and threads are overmolded in a substantially random fiber thermoplastic 38 onto a solid rod of thermoplastic composite with continuous longitudinal fibers 39. The random fibers in the overmolding provide higher shear strength in the head and threads than would be obtained by machining the bolt from a solid piece of composite with longitudinally aligned fibers.

Referring now to FIG. 5B therein is shown a bolt 43 where the head shaft and threads are overmolded of a random fiber composite 44 onto a tube 45 consisting of continuous fiber composite. In this case the tube is preferably supported internally during the molding operation to prevent it from tending to collapse under the heat and pressure of the overmolded component.

Referring now to FIG. 5C therein is shown a bolt 40 wherein the head shaft and threads are overmolded of a random fiber composite 41 onto a tube of continuous fiber composite 42, but in this instance the mandrel supporting the tube is tapered from each end so that the heat and pressure of the overmolding material cause the tube to constrict and be thermoformed onto the mandrel creating an undercut which increases the tensile strength of the bolt by resisting the tensile force which may otherwise pull the head off the bolt.

### EXAMPLE 1

Thermoplastic composite rods of 16.9 mm diameter are pultruded using the process described in Edwards et al—U.S. Pat. Nos. 6,165,604 & 5,891,560 with a matrix of Rigid Thermoplastic Polyurethane (RTPU). The rods are subsequently over molded using a Long Glass Filled RTPU containing 40% by weight of fibers of 12 mm length (LGF RTPU) to produce a continuous 25.4 mm threaded rod. Additionally samples of threaded rod are prepared by molding only, without the core of uni-directional composite. These samples plus samples of commercially available threaded rods produced by pultruding a thermoset composite and cutting threads of the same dimensions are subjected tensile and torque testing. The testing is carried out using the same commercially available composite nuts for all samples. The tensile test is carried out using two jigs containing 25.4 mm diameter holes which are gripped in opposing sides of a tensile test machine. A 20 cm length of each rod is threaded through the holes and secured with a standard nut on each end such that as the tensile tester is operated the jigs pull on the rods via the nuts. The force to break the specimens is recorded. The maximum and minimum values obtained are recorded below.

| Sample (all 25.4 mm | Max Tensile | Min Tensile |
|---|---|---|
| threaded rod) | strength (Kg) | Strength (Kg) |
| Thermoplastic composite rod | 7,270 | 6,360 |
| core with overmolded LGF | | |
| RTPU threads | | |
| Molded RTPU threaded rod | 1,000 | 1,140 |
| Thermoset composite | 4,090 | 2,820 |
| threaded rod with machined | | |
| threads | | |

Upon failure it is noted that all of the thermoset threaded rod samples fail as a result of the threads on the rod being sheared by the forces from the nut. The thermoplastic samples without the unidirectional core fail in tension at a very low load. The thermoplastic samples with the unidirectional core show a mixed failure mode with some samples failing by breaking the bond between the over molded composite and the pultruded core while others fail by stripping the threads on the nut without breaking the threaded rod. This indicates that somewhat higher values may well be obtained if a stronger nut is used.

Similar specimens are subjected to a torque test by inserting a short length of threaded rod through a 1″ thick plate and securing a standard nut on either side. One nut is held rigidly in a jig while the second nut is tightened down using a torque wrench. The maximum torque to cause failure is measured.

| Sample | Maximum Torque Nm |
|---|---|
| Thermoplastic composite threaded rod | 205 |
| Thermoset composite threaded rod | 150 |

### EXAMPLE 2

A thermoplastic composite rod of 6.4 mm diameter is pultruded using the materials and process described above. Rods are subsequently over molded using: 1) a Long Glass Filled rigid thermoplastic polyurethane containing 40% by weight of fibers (LGF RTPU); and 2) a Long Glass filled nylon 6/6 containing 35% by weight of fibers (LGF PA). Both fibers are of 12 mm length to produce a continuous 12 mm threaded rod. Samples of commercially available threaded rods produced by pultruding a thermoset composite and cutting threads of the same dimensions are obtained and all samples are subjected to tensile testing as described in Example 1. The force to break the specimens is recorded. The maximum and minimum values obtained are recorded below.

| | Max Tensile | Min Tensile |
|---|---|---|
| Sample | Strength (Kg) | Strength (Kg) |
| Thermoplastic composite | 1,820 | 1,640 |
| threaded rod (LGF RTPU) | | |
| Thermoplastic composite | 1,450 | 1,140 |
| threaded rod (LGF PA) | | |
| Thermoset composite | 1,140 | 1,050 |
| threaded rod | | |

### EXAMPLE 3

‘C’ shaped sections of approximate dimensions 64 mm deep with 38 mm flanges and a thickness of 3.3 mm are pultruded using the process described above. Some sections are produced with no subsequent overcoat, others with a thin layer (0.38 mm) of a glass filled rigid thermoplastic polyurethane containing 30% by weight of fibers. The samples are tested in three point bending with a center load applied to the tips of the flanges and supports 46 cm apart beneath the web. This test is quite severe as the load applied to the tips of the flanges causes buckling of the flanges and cracking in the corners between the flange and the web. For most composite applications, the onset of non-linearity in the force deflection curve caused by this buckling and cracking is more important than the ultimate failure load. The test data for each sample is recorded below.

| | | Ultimate | Onset of non- |
|---|---|---|---|
| Sample | Strength (Kg) | deflection (mm) | linearity (Kg) |
| Pultruded section | 210 | 10 mm | 91 |
| (no coating) | | | |
| Pultruded section | 370 | 18 mm | 255 |
| (GF RTPU coating) | | | |

### CONCLUSION

In conclusion, it is readily apparent that although the invention has been described in relation with its preferred embodiments, it should be understood that the instant invention is not limited thereby, but is intended to cover all alternatives, modifications and equivalents that are included within the scope of the invention as defined by the following claims.

What is claimed is:

1. An article, comprising: (a) one or more regions of continuous fiber composite; and (b) one or more regions of substantially randomly dispersed discontinuous fiber composite.

2. The article of claim 1, wherein the continuous fiber composite has a matrix of a thermoset polymer.

3. The article of claim 1, wherein the substantially randomly dispersed discontinuous fiber composite has a matrix of a thermoset polymer.

4. The article of claim 1, wherein the continuous fiber composite has a matrix of a thermoset polymer and the substantially randomly dispersed discontinuous fiber composite has a matrix of a thermoset polymer.

5. The article of claim 4, further comprising an adhesive between the continuous fiber composite and the substantially randomly dispersed fiber composite.

6. An article, comprising: (a) one or more regions of pultruded composite comprising a thermoplastic matrix and continuous fibers; and (b) one or more regions of thermoplastic composite reinforced with substantially randomly dispersed discontinuous fibers where the pultruded composite and the random fiber thermoplastic are bonded to each other without adhesive to form the article.

7. The article of claim 6 wherein the substantially random discontinuous fibers within the thermoplastic are substantially between one quarter of an inch and two inches in length.

8. The article of claim 6 wherein the thermoplastic matrix of (a) and (b) are selected from the group consisting of a thermoplastic polyurethane, an olefin, polybutylene terephthalate and polyethylene terephthalate, cyclic butylene terephthalate, PVC.

9. The article of claim 6 wherein (a) and (b) are positioned to resist the intended loads on the article.

10. The article of claim 6 wherein (b) is encapsulated within (a).

11. The article of claim 6 wherein (a) is encapsulated within (b).

12. The article of claim 6 wherein (a) has the shape of a tube and (b) is applied around (a) to resist shear and torque.

13. The article of claim 6 wherein the article is threaded rod the threads of which comprise (b).

14. The article of claim 6 wherein the article is a threaded fastener the exterior portion of which comprises (b).

15. The article of claim 13 or claim 14 in which (a) is deformed so as to create an undercut to enhance the joint between (a) and (b).

16. The article of claim 6, in which (b) is produced at substantially the same time that (a) is produced.

17. The article of claim 6 wherein (b) is molded over (a).
